(19) United States
(12) Patent Application Publication
(10) Pub. No.: US 2026/0078673 A1
(43) Pub. Date: Mar. 19, 2026

(54) METHOD FOR RELOCATING A MODULAR TROLLEY SYSTEM AND MODULAR TROLLEY SYSTEM

(71) Applicant: ABB Schweiz AG, Baden (CH)

(72) Inventors: Ratna-Kanth DITTAKAVI, vasteras (SE); Konsta KAINULAINEN, Vaasa (FI); Mehrzad ASHNAGARAN, Hunzenschwil (CH)

(21) Appl. No.: 19/396,690

(22) Filed: Nov. 21, 2025

Related U.S. Application Data
(63) Continuation of application No. PCT/EP2023/063614, filed on May 22, 2023.

(51) Int. Cl. E21F 17/06; E21F 13/00

(52) U.S. Cl. CPC E21F 17/06; E21F 13/006

(57) ABSTRACT

A method and a system for relocating a modular trolley system for a mining truck in a mine are provided. The modular trolley system includes a rectifier substation and a wire-pole-assembly. At least parts of the rectifier substation and the wire-pole-assembly include a transport coupling section for coupling the trolley system element to a transport coupling tool and for transporting the trolley system element. The method includes disconnecting at least some of the transportable trolley system elements at a first location of the mine, and coupling the respective trolley system elements to the transport coupling tool via the transport coupling section. The method additionally includes transporting the trolley system elements to a second location different from the first location. The method further includes re-connecting the transported trolley system elements of the modular trolley system at the second location of the mine.

### CROSS-REFERENCE TO RELATED APPLICATIONS

The present application is a continuation of, and claims priority to, International Patent Application No. PCT/EP2023/063614, filed on May 22, 2023, and titled “METHOD FOR RELOCATING A MODULAR TROLLEY SYSTEM AND MODULAR TROLLEY SYSTEM”, which is hereby incorporated by reference in its entirety.

### TECHNICAL FIELD

The present disclosure relates in general to a method for relocating a modular trolley system, in particular a method for relocating a modular trolley system for a mining truck. The present disclosure further relates to a relocatable modular trolley system, in particular a relocatable modular trolley system for a mining truck.

### BACKGROUND

Mining trucks are often used for transporting material hauled inside or out of a mine, such as an open pit mine. When transporting the material out of the mine, several parameters have to be considered, which may hamper the transport of material. The material is often heavy and the mining trucks are adapted to high loads. Some mining trucks transport up to 350 tons (inclusive payload) or even more. Additionally, for driving out of the mine, steep inclines may have to be overcome. In some mines, the mining trucks have to overcome a vertical gain of about 500 meter or more. For such transports, the energy consumption is high.

For mining trucks, trolley systems may be used, which is an engineered solution to provide electrical power to haul trucks which are electrified. For instance, the mining trucks have a battery onboard for delivering the power to an electrical drive of the mining truck. The connection to a trolley line, being, for example, provided at a place of high energy consumption, allows direct supply of electricity to the truck, for example, in the steep inclines. Some kinds of mining trucks have an additional diesel engine for avoiding a sudden stop of the electric drive and for delivering current to the electric drive of the mining truck.

The Trolley system is a large CAPEX (capital expenditures) investment in the mine and, often, the mine layout is continuously changing. For instance, the hauling routes are moved in various frequencies based on the type of the mine. When the hauling route changes, the existing installed trolley system remains in the old location unused or to be scrapped. Another problem is also the carbon foot print of the equipment for a trolley system being purchased for the mine. The equipment contributes to emissions being classified as scope 3 emissions of the mine.

In view of the above, there is a need to address at least one of the abovementioned limitations and to propose a method and system to overcome the abovementioned problems.

### BRIEF DESCRIPTION

The objects of the present disclosure are achieved by the subject-matter of the independent claim. Further exemplary embodiments are evident from the dependent claims and the following description. The embodiments and features, if any, described in this specification that do not fall under the scope of the independent claim are to be interpreted as examples useful for understanding various embodiments of the present disclosure.

In an embodiment, the present disclosure relates to a method for relocating a modular trolley system for a mining truck in a mine. According to embodiments described herein, the modular trolley system includes a rectifier substation including a rectifier transformer; a wire-pole-assembly including a foundation, a wire holding beam, and a pole element mounted to the foundation and holding the wire holding beam; and conductors including a contact wire and a feeder wire. At least the rectifier substation and the wire-pole-assembly, or the foundation, the wire holding beam, and the pole element, are transportable trolley system elements which comprise a respective transport coupling section configured to: couple the transportable trolley system element to a transport coupling tool; and transport the transportable trolley system element. According to embodiments described herein the method includes disconnecting at least some of the transportable trolley system elements of the modular trolley system at a first location of the mine, and coupling the respective at least some of the transportable trolley system elements to a transport coupling tool via the transport coupling section; transporting the at least some of the transportable trolley system elements of the modular trolley system to a second location different from the first location; and re-connecting the transported trolley system elements of the modular trolley system at the second location of the mine.

In an embodiment, the present disclosure discloses a relocatable modular trolley system configured to relocate a modular trolley system according to embodiments described herein. The relocatable modular trolley system includes a rectifier substation including a rectifier transformer; a wire-pole-assembly including a foundation, a wire holding beam, and a pole element mounted to the foundation and holding the wire holding beam; conductors including a contact wire and a feeder wire; and a suspension system configured to hold the conductors placed on the wire holding beam. According to embodiments, at least the rectifier substation and the wire-pole-assembly, or the foundation, the wire holding beam, and the pole element, are transportable trolley system elements which comprise a respective transport coupling section configured to: couple the respective trolley system element to a transport coupling tool; and transport the respective trolley system element. The relocatable modular trolley system is configured to disconnect at least some of the transportable trolley system elements of the modular trolley system at a first location of the mine, and couple the respective at least some of the transportable trolley system elements to the transport coupling tool via the transport coupling section. The relocatable modular trolley system is configured to transport the at least some of the transportable trolley system elements of the modular trolley system to a second location different from the first location, and re-connect the transported trolley system elements of the modular trolley system at the second location of the mine.

In an embodiment, the present disclosure discloses the use of a relocatable modular trolley system according to embodiments described herein in a method according to embodiments described herein.

Systems of varying scope are described herein. In addition to the aspects and advantages described in this summary, further aspects and advantages will become apparent by reference to the drawings and with reference to the detailed description that follows.

### BRIEF DESCRIPTION OF DRAWINGS

The subject matter of the present disclosure will be explained in more detail in the following text with reference to exemplary embodiments which are illustrated in the attached drawings.

FIG. 1 shows a schematic drawing of a trolley system in a mine according to an embodiment of the present disclosure.

FIG. 2 shows a schematic flow chart of a method for relocating a modular trolley system for a mining truck according to an embodiment of the present disclosure.

FIG. 3 shows a schematic view of a relocatable modular trolley system for a mine according to an embodiment of the present disclosure.

FIGS. 4 to 9 show schematic drawings of a disassembly of a relocatable modular trolley system at a first location according to an embodiment of the present disclosure.

FIGS. 10 to 13 show schematic drawings of a re-assembly of the relocatable modular trolley system disassembled in FIGS. 4 to 9 at a second location according to an embodiment of the present disclosure.

The reference symbols used in the drawings, and their meanings, are listed in summary form in the list of reference symbols. In principle, identical parts are provided with the same reference symbols in the figures.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment can be applied to a corresponding part or aspect in another embodiment as well.

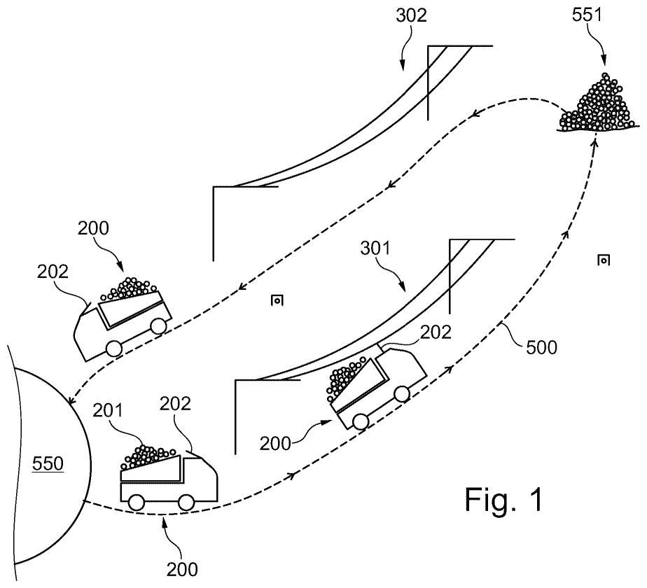

FIG. 1 shows an overview of a mine with a trolley system 100 for electrical charging a trolley assisted mining truck 200 according to some embodiments described herein.

Typically, FIG. 1 shows a mine 550, which may in particular be an open pit mine. In some embodiment, a mine as referred to herein may be an underground mine. One or more trolley assisted mining trucks 200 (in the following often just described as mining trucks 200) transport material 201 hauled from the loading location in the mine 550 along a transport cycle 500 (shown as dashed line in FIG. 1). According to some embodiments described herein, the mining trucks 200 upload a material load 201 at the loading location in the mine, for example, at the ground of an open pit mine. The mining truck 200 transports the load 201 along the transport cycle 500 to an unloading place 551, where the material load 201 of the mining truck 200 is unloaded from the mining truck. The empty mining truck 200 goes from the unloading place 551 to the mine 550, again along the transport cycle 500. At the mine 550, the transport cycle 500 absolved by the mining truck 200 begins again with uploading a material load 201 on the mining truck 200.

As can be seen in the embodiment of FIG. 1, parts of the transport cycle 500 according to embodiments described herein may be equipped with a trolley line 301, 302. In particular, a part of the transport cycle 500 being equipped with trolley lines may be a part of the transport cycle having a steep incline (such as a part of the transport cycle leading out of the pit, or into the pit), or other power consuming conditions (like for instance environmental conditions, such as ground conditions or the like).

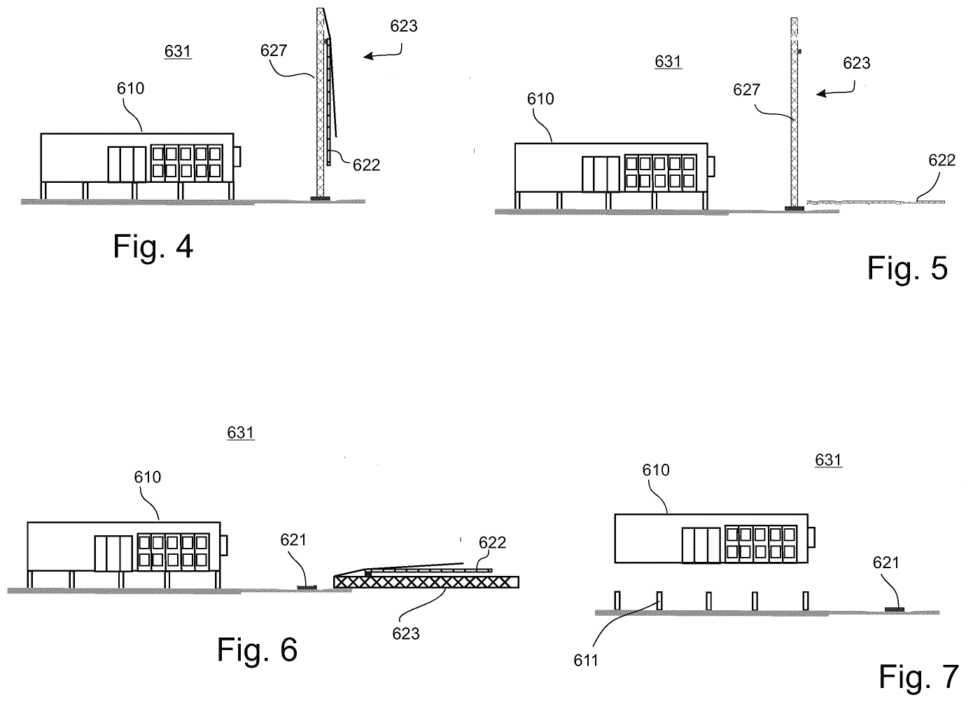

According to embodiments described herein, a trolley line may be understood as including current conducting wires, such as contact wires. Typically, the contact wires of a trolley line according to embodiments described herein may be placed in a height and at a location, where the mining truck is able to contact the trolley line, in particular via the pantograph of the mining truck (as can exemplarily be seen in FIG. 3 as pantograph 202). Typically, the trolley line may be held by a wire-pole-assembly 623, including a foundation 621, a wire holding beam 622, and a pole element 627 mounted to the foundation 621 and holding the wire holding beam 622, and may be supported by struts, as can for instance be seen in FIG. 3.

According to some embodiments described herein, the mining truck includes a trolley or pantograph 202, especially for being connectable to a contact wire 625.

According to embodiments described herein, a mining truck (or trolley assisted mining truck as sometimes used herein) may be understood as a truck being adapted for transporting (heavy) loads out of a loading area of a mine, such as an open pit. The trolley assisted mining truck may have an electric drive and a battery for providing power to the electric drive. In particular, the trolley assisted mining truck may include a pantograph for propelling the truck without use of power from the battery, or for charging the battery of the mining truck, or for a combination thereof, especially via the contact of the pantograph with a trolley line. Typically, the trolley assisted mining truck may be adapted for a weight of up to 600 tons, or more. Typically, the mining truck as described herein may have a power of typically between about 150 kW MW and about 7 MW, more typically between about 400 kW and about 6MW, and even more typically between about 2 MW and about 5 MW. In some embodiments, the mining truck as described herein may have a power of about 5 MW.

Typically, a trolley system is a large CAPEX (capital expenditures) investment in a mining system. Also, the mine layout is continuously changing and the hauling routes are moved in various frequencies based on the type of the mine. When the hauling route changes the existing installed trolley system will remain in the old location unused or to be scrapped. Another problem is the carbon foot print of the equipment of the trolley system being purchased for the mine. The equipment contributes to the emission amount of the mine (especially, to scope 3 emissions of the mine according to the Greenhouse Gas (GHG)-Protocol). Reusability reduces the emissions and overall improve/reduce the carbon footprint of the mine. Embodiments described herein address the problem of reducing emission, sparing costs and supporting reusability with methods, processes, and design of the trolley system. Especially, the trolley system according to embodiments described herein is able to be relocated and reused in a different location.

Known trolley systems are fixed systems and are not intended to be reusable and relocatable. Embodiments described herein refer to methods, process and design of a trolley system which is relocatable and reusable. The design of the traditional trolley system is changed to enable the methods and process of relocation.

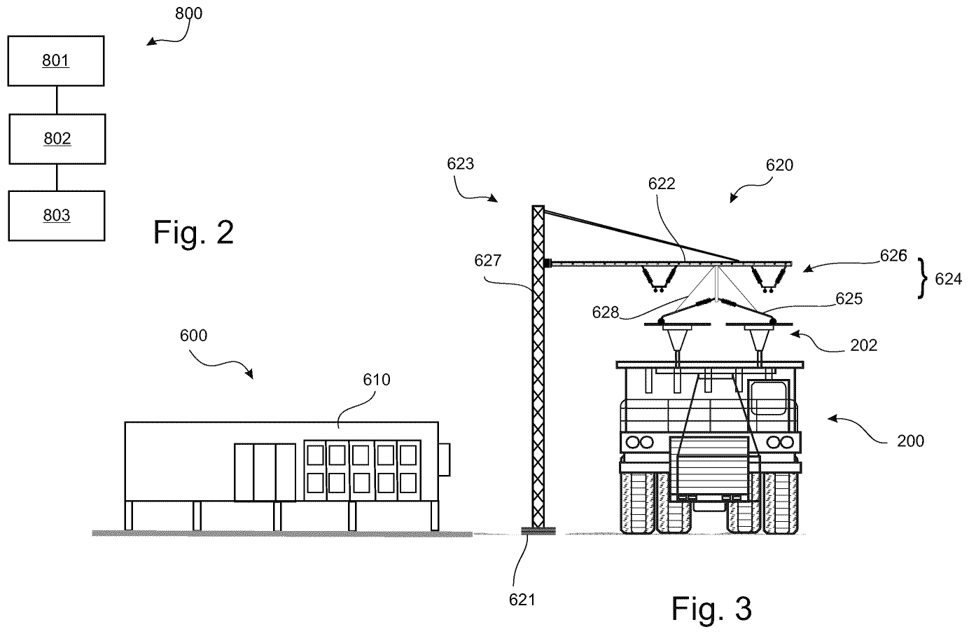

The method 800 according to embodiments described herein, and especially the single method activities, is/are shown in FIG. 2. FIGS. 3 to 13 are referred to for explaining the method activities and the trolley system according to some embodiments in more detail.

According to embodiments described herein, a method is provided for relocating a modular trolley system 600 for a mining truck 200 in a mine. Typically, the trolley system may be applicable to mining industry both for open pit mines and underground mines. In some embodiments, the relocation features of the trolley system are applicable to open pit mine but are not restricted to.

FIG. 3 shows a modular trolley system 600 according to embodiments described herein. Typically, the modular trolley system 600 includes a rectifier substation 610 including a rectifier transformer. Further, the modular trolley system 600 includes a wire-pole-assembly 623 including a foundation 621, a wire holding beam 622 (which may especially be a cantilever arm), and a pole element 627 mounted to the foundation 621 and holding the wire holding beam 622. According to embodiments described herein, the modular trolley system 600 includes conductors 624 including a contact wire 625, a feeder wire 626, and, especially, a delta wire 628.

According to some embodiments, a modular trolley system may be understood as a system including several modules or elements, which can be assembled, disassembled and re-assembled. In particular, the modules of the modular trolley system as referred to herein may be modules being adapted (for example, by respective equipment) to be assembled, disassembled and re-assembled. For instance, the modules or elements of the modular trolley system may include equipment, elements, units, parts, partitions, devices, and the like for assembling, disassembling and re-assembling of the modules or elements of the modular trolley system. According to embodiments described herein, some elements of the modular trolley system may include a respective transport coupling section for coupling the respective trolley system element to a transport coupling tool. In particular, at least some of the modules or elements of the herein described modular trolley system may be transportable, especially transportable by a connection or link between a respective transport coupling section and a transport coupling tool. In some embodiments, at least some of the elements or modules of the modular trolley system according to embodiments described herein may be constructed with standardized units or dimensions for flexibility and variety in use.

Typically, the relocation aspect of the modular trolley system may already be considered during designing the trolley system. Preparing and understanding the limitations of reusability of a modular trolley system from the very design phase is useful for designing a working modular trolley system. A few considerations to be exemplarily noted are explained in the following. Typically, several aspects of the relocation may be considered as part of the trolley design and overall mine design. For instance, the specifications of the actually running trolley system shall be reusable in the new location. The specifications may include the impacting characteristics like ramp slope, number of trucks, voltage and current of trucks, etc. The specifications being substantially the same at the first location and the second location, is useful for relocation. Typically, the foundation design and pole element design may be considered based on relocatability (details are explained below in the respective embodiments). In some embodiments, pole element and foundation may have transport coupling sections installed to be able to safely lift and transport to the second location. Finally, the foundations and supporting groundwork at the second location is typically prepared in advance before starting the relocation.

According to embodiments described herein, at least the rectifier substation 610 and the wire-pole-assembly 623, or parts of the wire-pole-assembly 623, are transportable trolley system elements including a respective transport coupling section for coupling the transportable trolley system element to a transport coupling tool and for transporting the transportable trolley system element. For instance, the elements or modules of the modular trolley system are transportable with the transport coupling section and transport coupling tool being coupled together.

According to some embodiments, the transport coupling section as referred to herein may include at least one of a hook, a groove, a cavity, a belt, a wheel, a reception for a wheel, a track wheel, a reinforced section, a magnetic section, (parts of) a shackle, counterparts for rails or tracks, sliding sections (for instance sections being suitable for sliding on rails or tracks, for example, by material, geometry, or the like), a geometry of the transport coupling section interacting with the rails or tracks, and the like. Typically, the pole element 627 and/or the foundation 621 include hooks installed for lifting and subsequent transport of the pole element and/or the foundation 621 from a first location 631 to a second location 632 of a mine.

According to some embodiments, which may be combined with other embodiments described herein, the transport coupling section of different trolley system elements (such as for instance the substation and the wire-pole-assembly) may have substantially the same shape for being coupled to the same kind of transport coupling tool. For instance, at least some of different trolley system elements may be provided with a transport coupling section grippable by a hook, especially a hook of a crane. Additionally, or alternatively, at least some of different trolley system elements may be provided with a transport coupling section being magnetic for being grippable (or, rather, liftable) by a magnet. Similar examples can be made for each kind of transport coupling section (see examples above) and transport coupling tool. In this way, the relocation process is facilitated.

In some embodiments, the transport coupling tool may be understood as a sort of counterpart to the transport coupling section of a transportable trolley system element. Typically, the transport coupling section and the transport coupling tool of the transportable trolley system element (so to say the counterpart) provide a connection to each other allowing transport of the trolley system element, especially from a first location 631 of a mine to a second location 632 of a mine, but also from the mounted condition to a truck or the like. According to some embodiments, the transport coupling tool may be a one of a hook, a groove, a cavity, a belt, a wheel, a track wheel, a rail, a track, a reinforced section, a gripping tool, a magnetic section, (parts of) a shackle and the like. According to some embodiments, a transport coupling tool may be used for disassembly or disconnecting trolley system elements.

As may be understood, the transport coupling section and the transport coupling tool may support or lead to the trolley system being relocatable according to some embodiments described herein. Especially, the trolley system may be relocatable from a first location 631 of a mine to a second location 632 of a mine (which may, in some embodiments, be the same mine, or another mine). According to some embodiments, the distance between the first location 631 and the second location 632 may typically range from about 50 m to about several hundred meters, but may typically also range up to several kilometers.

The method 800 as exemplarily shown in FIG. 2 according to embodiments described herein includes at block 801 disconnecting at least some of the transportable trolley system elements of the modular trolley system at a first location 631 of a mine. For instance, FIGS. 3 to 8 show the disassembly and disconnection of at least some of the parts of the relocatable trolley system.

According to some embodiments described herein, disconnecting can include, for example, disconnecting from other parts of the trolley system such as disconnecting from the conductors 624 and/or—in case of the transportable trolley system element being a part of the wire-pole-assembly such as the wire holding beam 622 or the pole element 627—disassembling it from other part(s) of the wire-pole-assembly. Re-connecting may be understood likewise, wherein the trolley system element does not have to be connected to the same other parts from which it had been disconnected but may be re-connected to different but, in some embodiments, functionally analogous parts, for example, to a different foundation.

According to embodiments described herein, the disassembly or disconnection of at least some parts of the relocatable trolley system may include coupling the respective transportable trolley system elements to the transport coupling tool via the transport coupling section. For instance, for the purpose of disassembly or disconnection of the elements of the relocatable trolley system, the respective element may be connected, gripped, grabbed, taken, and/or coupled at the transport coupling section.

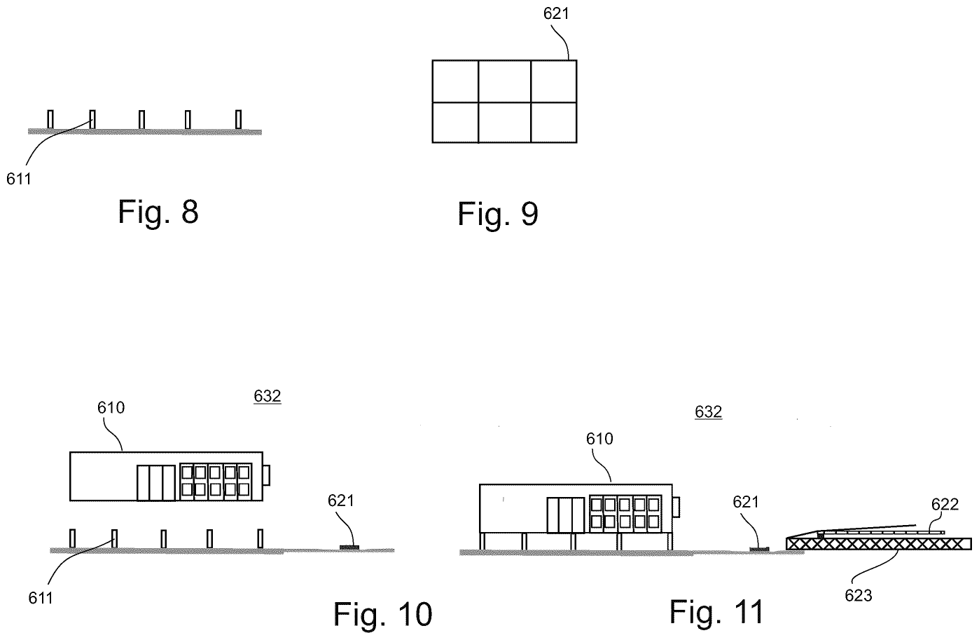

In particular, FIG. 4 shows the disassembly of the wire holding beam 622. In some embodiments (as for instance shown in FIG. 4), the wire holding beam 622 may be folded for disassembly. In particular, the wire holding beam 622 is folded towards the pole element 627 in the example shown in FIG. 4. For instance, the wire holding beam 622 may be folded by a kind of hinge, joint or link allowing a rotational movement of the wire holding beam 622 towards the pole element 627. In some embodiments, the wire holding beam 622 being folded towards the pole element 627 may be fixed to the pole element 627 for transport. For instance, the wire holding beam may (temporarily) be tied, or clamped, or otherwise fixed to the pole element 627 for avoiding a movement of the wire holding beam 622 during transport.

According to some embodiments described herein, the wire holding beam may be a cantilever arm. Typically, the wire holding beam 622, especially the cantilever arm is connected to the pole element 627 using supporting struts, for example, supporting struts of the pole element 627.

Typically, a suspension system may be provided with the trolley system. According to some embodiments, the suspension system may be adapted for holding the conductors or wire(s) at the wire holding beam. In some embodiments, the relocatable trolley system includes conductors, such as conductors 624, as exemplarily shown and described with respect to FIG. 3. According to some embodiments, the conductors 624 as referred to herein may include the contact wire 625 and the feeder wire 626 and substantially no messenger wire (as for instance used in known systems). In some embodiments, the relocatable trolley system does not include a dropper for the overhead system 620.

Generally, the catenary system may be based on various wires. According to some embodiments, which may be combined with other embodiments described herein, one of the design changes (compared to known trolley systems) to enable the relocatability may be to remove (or refrain from using) the messenger wire and suspend the contact wire using delta wires 628 (as exemplarily shown in FIGS. 3 and 13) at the location of the wire holding beam. Typically, a delta wire may be provided in the form of two wires forming a substantially triangular shape, more typically together with the contact wire. For instance, two delta wires meet together at one point, forming the substantially triangular (or delta-like) shape. In some embodiments, the delta wires are connected to the wire holding beam 622, especially at the point, where the delta wires meet. According to some embodiments, delta wires may be used to hold the contact wire. Waiving the messenger wire (used in known designs) and the droppers (which may be provided every 10 meters in known designs) and using delta wires instead in some embodiments described herein, helps to facilitate disassembling the wire-pole-assembly at the first location and to transport the wire-pole-assembly to the second location. Also, re-assembling is facilitated. Typically, using a delta wire helps making the construction of the wire-pole-assembly a lightweight construction, which is useful for relocatability.

Typically, the following wires may be parts (especially the only parts) of the catenary system: feeder wire, contact wire, delta wires and, optionally, droppers (which may be omitted in some embodiments).

Typically, feeder wires may be chosen based on the project specification and are typically stranded aluminum wires which are supplied rolled in drums. In some embodiments, feeder wires may be detached and rolled into the same/similar drums for transport and relocation. Typically, the connection wires between feeder wire and messenger wire may be disconnected, relocated, and be reinstalled in the second location.

According to some embodiments described herein, contact wires may be chosen based on the specific project. Typically, contact wires may be (specific profiled) sold copper wires. Contact wires are typically sensitive and often cannot be rolled up without damaging the profile in any case. In some embodiments, the contact wires may be replaced (especially completely) with new contact wires for the second location (unless, in some embodiments, the transport distance is so short that the contact wires can be carefully dragged on the ground without causing bends or other damage).

According to some embodiments, the tension of the wire(s) provided, for example, by a tension system may be released for disconnection, and the wires may be detached in order to relocate. In some embodiments, the jumper connections between feeder wire and messenger wire (if any), messenger wire and contact wire may be disconnected and removed. The connection wires can be relocated and reused according to some embodiments described herein.

According to some embodiments, the suspension system may be held and left at the wire holding beam, when detaching or folding the wire holding beam towards the pole element. In some embodiments, the suspension system, especially together with the wire holding beam may be secured to the pole element. In this way, the risk of damage of the equipment during the relocation is minimized.

Typically, the conductors, wires and cables as referred to herein may be external conductors and cables and may especially be used for being connected between the rectifier substation, a rectifier transformer, the overhead line (OHL) and an (upstream) AC power supply. According to some embodiments described herein, which may be combined with other embodiments described herein, the conductors and cables may especially include the following: Incoming supply cables from (upstream) MV power distribution, cables between rectifier transformer and rectifier substation, cables between rectifier substation and overhead system; and any cables and conductors including power cables, auxiliary cables, communication cables, and earthing cables.

Typically, the cables may be disconnected after de-energizing the substation completely. The disconnected cables can possibly be relocated and reused (in some embodiments, provided that the second location and installation have similar distances from the rectifier substation to the overhead line and from the rectifier substation to a rectifier transformer). If an accurate positioning of the main equipment in this way is not possible in the second location (for example, from a practical point of view), then (at least part of) the conductors and cables may be renewed. The accurate estimation of re-cabling may naturally be done with a site-by-site assessment.

A “similar” distance, or a substantially same distance as referred to herein may be understood in that the distance may have a deviation of typically up to 15% of the distance, more typically up to 10% of the distance, and even more typically up to 5% of the distance. According to some embodiments, a substantially same shape as referred to herein may be understood in that the geometry is comparable, analogue, congruent, or has the similar or substantially the same size (which may be defined as the similar or substantially same distance). In some embodiments, a similar or substantially same shape may be understood as a shape being obtainable from another shape by uniformly scaling (enlarging or reducing), possibly with additional translation, rotation and reflection.

According to some embodiments, re-usable cables may be rolled up for transport from the first location to the second location or may be pulled or dragged from the first location to the second location on the ground (this may especially be used, if the distance between the first location and the second location is rather short, for example, up to a few hundred meters).

FIG. 5 shows an embodiment, in which the wire holding beam 622 is detached from the pole element 627, especially completely disconnected from the pole element 627, typically along with the suspension system, for relocating the wire holding beam. In the embodiment shown in FIG. 5, the pole element 627 and the wire holding beam 622 may separately be transported from the first location 631 to the second location 632. According to some embodiments, the wire holding beam 622 and the pole element 627 may be transported together (for example, on the same truck, on the same track, or generally in the same way), but as separate parts of the trolley system.

According to some embodiments, the disassembly of the wire holding beam 622 (be it by folding or by complete disconnection from the pole element 627) may be performed by gripping the wire holding beam 622 at the transport coupling section by a transport coupling tool and move the wire holding beam respectively. For instance, in the case that the transport coupling section is a loop, or lug, the transport coupling section may be moved by coupling the loop to a hook (acting as a transport coupling tool) or the like.

FIG. 6 shows an embodiment, in which the wire holding beam 622 is folded towards the pole element 627 and the pole element 627 is disassembled, or disconnected, from the foundation 621. According to some embodiments, which may be combined with other embodiments described herein, the struts of the pole element may be dis-assembled, too. Especially, the disassembly of the struts may decrease the weight of the pole element to be transported to the second location. According to some embodiments, which may be combined with other embodiments described herein, the pole element may be designed for decreasing the weight of the pole element to be transported. For instance, the pole element may have a tapering shape, may include a material being less heavy than known pole elements, may have an alternative design of the struts compared to known pole elements, or the like.

Typically, there are different pole elements, especially depending on the intended use. For instance, there may be standard pole elements for being placed in straight ramps, pole elements in curves, and weight tension pole elements.

According to some embodiments, the disassembly of the pole element 627 may be performed by gripping the pole element 627 at the transport coupling section and move the pole element 627 respectively. For instance, in the case that the transport coupling section is a loop, or lug, the pole element may be moved by coupling the loop to a hook (acting as a transport coupling tool) or the like. In other embodiments (which is not limited to the pole element 627, but may be applied to other parts of the modular trolley system as well), the transport coupling section may be an area of the pole element 627 (or the respective part to be disconnected) being adapted to be gripped by a gripping tool acting as a transport coupling tool. For instance, the area may be adapted by preparing the surface of the area, for example, by designing a defined roughness facilitating the gripping of the respective part, or by designing the area as a substantially flat area.

According to some embodiments described herein, the wire-pole-assembly 623 may also be denoted as overhead line system. Typically, the overhead line system may include at least some of the following: one or more poles, a respective number of foundation, a respective number of cantilever arms (or wire holding beams), suspension systems, conductors (especially feeder wire, contact wire, and possibly delta wire 628 with droppers, which may be omitted in some embodiments for facilitating relocatability), an (auto) tension weight system, a fixed tension weight system, a surge arrestor, cables, and civil foundations. Typically, the overhead line system may be denoted as the main part of the trolley system to provide required electrical energy to the trucks via the pantograph.

FIG. 7 shows the rectifier substation 610 being disconnected from the ground or from support elements 611 supporting the rectifier substation 610. According to some embodiments, the purpose of the rectifier substation is to convert AC to DC to feed power and fit to truck operational VDC range, in a safe and reliable way. Typically, rectifier substations sizing is designed based on the load duty by truck under trolley operation. Typically, the rectifier substations of the trolley system consist of (mainly on a broad level): a substation, a rectifier transformer, and external cables.

According to some embodiments, the rectifier substation may include at least some of the following elements: a 3-winding transformer, a 12-pulse bridge rectifier, a Medium Voltage (MV) switchgear, auxiliary systems, protection systems, control and monitoring system, a HVAC (heating, ventilation, air conditioning) system, a pressurization system, cables, and civil foundations.

In some embodiments, the rectifier substation is movable (and transportable to a second location) with internally installed respective electrical hardware, especially operable installed electrical hardware. Typically, the rectifier substation may be de-energized and disconnected from power supply and from further connections (such as external cables) and lifted for disconnecting. In some embodiments, the rectifier substation may be lifted using a crane, which may for instance utilize lift ropes. Especially, the rectifier substation may mechanically be detached from a support 611 in order to lift it. According to some embodiments described herein, the rectifier substation may be placed on a truck (eventually with other parts of the relocatable trolley system) to be relocated to new location. Additionally, stairs or other equipment being mounted on the outside of the rectifier substation may be dismantled before lifting the rectifier substation, and may be reassembled afterwards. In some embodiments, the support 611 for the rectifier substation may also be disconnected or disassembled at the first location 631 to be transported to the second location 632.

FIG. 8 shows the support 611 for the rectifier substation according to some embodiments. In some embodiments, the foundation or support for the rectifier substation may include steel pillars, concrete beams, or the like. According to some embodiments, the support 611 for the rectifier substation may also be reused at the second location 632. In some embodiments, the support 611 may also include one or more transport coupling sections, or may be grippable anyway by its geometry. According to some embodiments, rectifier transformers may independently be installed next to the rectifier substation, typically having an own enclosure. Rectifier transformers may typically be constructed to be flexible and relatively easy to relocate. Typically, a rectifier transformer needs a stable foundation. The foundation for the rectifier transformer may be designed to be able to detach the transformer, lift and then relocate to new location, for example, by having one or more transport coupling section(s). Before transport of the rectifier transformer, the rectifier transformer is de-energized, and disconnected in order to be relocated. The rectifier transformer (but also other parts or elements of the trolley system) may be lifted using a slew crane, may be loaded onto a truck (eventually with other parts or elements of the trolley system), secured and relocated to a second location 632. Especially, a slew crane may also be used at the second location 632 to unload and place the respective element on a foundation, such as a pre-prepared foundation at the second location 632.

FIG. 9 shows a top view of the foundation 621 of the pole element 627 according to some embodiments. Both of the foundations or supports 611 and 623, one of them, or none of them may be transported to the second location 632.

In the embodiment shown in FIG. 9, the foundation for the pole element is shown in a partitioned way. In particular, the foundation 621 is partitioned into single foundation elements. In the example of FIG. 9, it is six foundation elements. Typically, the number of foundation elements of a partitioned foundation may be suitably chosen for ensuring a safe transport of the foundation. Typically, the number of foundation elements may be between 2 and 20, more typically between 4 and 16, and even more typically between 4 and 10. The method according to some embodiments may include disconnecting the foundation 621 into the single foundation elements. Especially, the method of relocating a trolley system may include transporting the foundation 621 of the pole element as single foundation elements. According to some embodiments, a partitioned foundation may be denoted as a relocatable foundation.

According to some embodiments, the relocation of a buried foundation may include digging out the foundation (or the foundation elements), lifting up the foundation (or the foundation elements), load it onto a truck, relocate to the second location 632.

In some embodiments, which may be combined with other embodiments described herein, the foundation of the pole element may generally be made from concrete. Typically, the foundation may be buried in the ground.

According to some embodiments, the modular trolley system may further include elements like auxiliary systems or low voltage (LV) systems. Typically, the auxiliary systems or low voltage (LV) systems may include at least some of the following elements: a height measurement for the mining truck, a traffic control, an automation solution, LED light indicators, and the like. In some embodiments, which may be combined with other embodiments described herein, the auxiliary systems or low voltage (LV) systems may also be relocatable systems. Typically, the auxiliary systems or low voltage (LV) systems may include a transport coupling section as described herein for being relocatable from the first location to the second location.

Typically, the at least some of the transportable trolley system element(s) of the modular trolley system 600 are transported from the first location 631 to a second location 632 different from the first location 631 in block 802 of method 800 (as exemplarily shown in FIG. 2).

According to some embodiments, the term “transport” may be understood in that it encompasses: coupling the respective element to a transport coupling tool, loading and carrying it, for example, on a truck, eventually uncoupling, moving, for example, by the truck, eventually again coupling to the transport coupling tool, and unloading.

According to some embodiments described herein, the first location may be understood as a location in a mine, where the trolley system including the rectifier substation and the complete wire-pole-assembly has been run or operated. According to some embodiments described herein, a second location may be understood as a location different from the first location, where the trolley system including a rectifier substation and a wire-pole-assembly will be run or operated. In some embodiments, the first location and the second location may be in the same mine, or in different mines. Typically, the relocatable trolley system as described herein (and especially the transport coupling sections of the relocatable trolley system) may be adapted to the distance between the first location and the second location. For instance, if the first location and the second location are quite narrow to each other (such as up to a few hundred meters), the elements of the relocatable trolley system as described herein may be adapted for being transported on rails or tracks from the first location to the second location. Typically, the rails or tracks may act as transport coupling tool. According to some embodiments, the method of transporting the trolley system elements may include mounting non-permanent rails or tracks between the first location 631 and the second location 632 and, especially, transporting the trolley system elements of the modular trolley system over the non-permanent tracks. In some embodiments, non-permanent tracks or rails may be understood as tracks or rails, which are provided for a defined and limited period of time. For instance, the rails or tracks may be provided during the relocation action. In some embodiments, the non-permanent rails or tracks are removed after the relocation is completed. In other embodiments, the rails or tracks are left in place after the relocation.

Typically, the elements of the relocatable trolley system (and especially the transport coupling section) being adapted for being transported on rails or tracks may include respective counterparts, wheels, reception(s) for wheels, sliding sections (for instance sections being suitable for sliding on rails or tracks, for example, by material, geometry, or the like), a geometry of the transport coupling section interacting with the rails or tracks, and the like. In some embodiments, which may be combined with other embodiments described herein, some of the elements to be transported may also be suitable for being pulled from the first location to the second location on the ground.

According to some embodiments, especially if the trolley system is to be relocated over a short distance (up to 80, or 100 meters) a truck, lorry, or even rails may not be chosen to be used. Typically, a short distance relocation (especially of the rectifier substation) can potentially be handled by a crane and suitable positioning of the crane in relation to the first and the second location. Accordingly, the transport coupling section is designed respectively, for example, by choosing hooks, shackles, and the like as a transport coupling section.

In the case that the second location has a large distance to the first location (such as a kilometer or more), the elements of the relocatable trolley system (and especially the transport coupling section) may typically be adapted for being transported by a vehicle, such as a truck or the like. An element of the relocatable trolley system (and especially the transport coupling section) being adapted for being transported by a vehicle may be adapted by choosing a suitable size of the element, a respective possibility to disassemble parts or elements of the trolley system (such as the foundation being partitioned as described above), a respective surface (such as one substantially plane surface for reliably lying on the truck loading area), and the like.

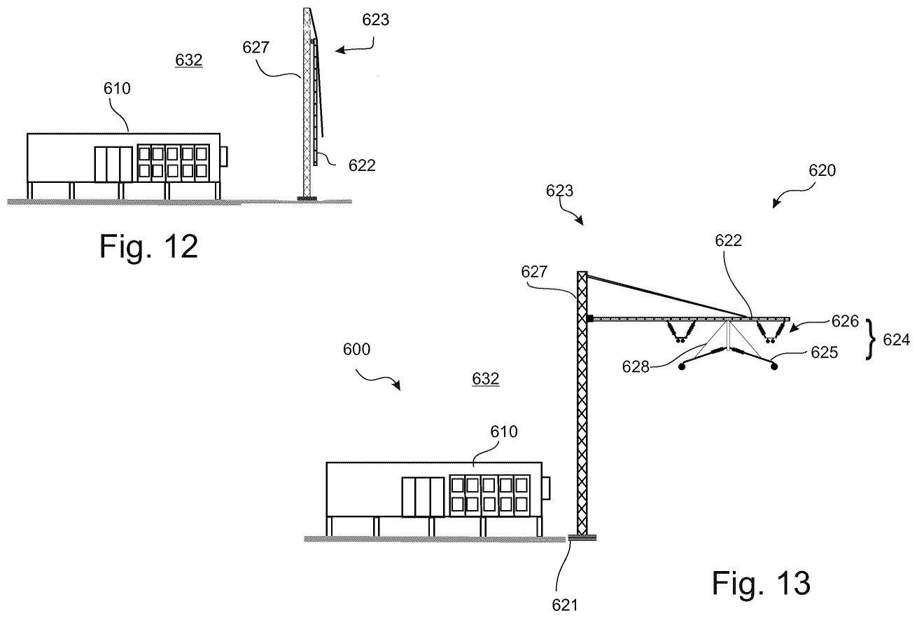

According to some embodiments described herein, the second location 632 may be prepared for the assembly of the relocatable trolley system. For instance, the ground may be prepared for the trolley system. In some embodiments, the second location 632 may be provided with a respective foundation or support for the rectifier substation (as for instance support 611 as shown in FIG. 10). In some embodiments, the disassembled and transported foundation 621 for the pole element and the support 611 for the rectifier substation may be used, as can be seen in FIG. 10.

According to embodiments described herein, the method for re-locating a trolley system includes in block 803 re-connecting the transported trolley system element(s) of the modular trolley system 600 at the second location 632 of a mine. Typically, re-connecting may include re-assembling of (at least some of the) parts having been disassembled before (at the first location).

In the following description of the re-connection of the trolley system elements, it may be understood that the trolley system elements which are re-assembled may (at least partly) be the same trolley system elements, which have been dis-connected in FIGS. 4 to 8 according to embodiments described herein.

In the embodiment exemplarily shown in FIG. 10, the foundation 621 for the pole element and the support 611 for the rectifier substation 610 are provided at the second location 632. According to some embodiments, the foundation (or the foundation elements) are installed in the second location 632. Typically, a hole is dug out to bury the foundation 621 at the second location 632.

Typically, the rectifier substation may be installed directly on the respective support 611. In the case that the foundation 621 has been transported from the first location 631 in single foundation elements, the foundation 621 is re-assembled by reconnecting the single foundation elements of the foundation to form the foundation 621. In particular, the method for relocating a trolley system may include providing additional elements for the foundation (especially new elements, which have not yet been used as foundation elements before) and using the additional foundation elements for the foundation of the pole element at the second location. According to some embodiments, additional foundation elements may help increasing the stability of the foundation 621 at the second location 632.

Typically, the foundation 621 is fixed, anchored, or set in the ground. According to some embodiments described herein, the foundation is adapted for holding the pole element 627, for example, by adapting the weight, strength, geometry, material, size and/or other properties of the foundation to the load of the pole element 627 and the wire holding beam 622 to be held by the foundation.

In FIG. 11, the pole element 627 is mounted at the second location 632. According to the embodiments exemplarily shown in FIG. 11, the wire holding beam 622 is folded towards the pole element 627 and was transported to the second location together with the pole element 627. According to some embodiments, the suspension system may also be transported together with the wire holding beam 622.

FIG. 12 shows the erection of the pole element 627 and the wire holding beam 622 at the second location 632. In FIG. 12, the wire holding beam 623 is still folded (and, in some embodiments, linked) to the pole element 627.

FIG. 13 shows the montage of the wire holding beam 623 in the correct operational position. Especially, the wire suspension system and the wires are also mounted for being ready for operation.

According to some embodiments, the re-erection of the transported elements of the modular trolley system may include the use of technicians, installation personal, cranes, slew cranes, tractors, trucks (especially with trailer), lifts, high lifts, rails, tracks, and the like.

It may be understood that the measures for making a trolley system modular and relocatable according to embodiments described herein consider the special circumstances of a mine (be it an open mine, or an underground mine). According to some embodiments described herein, dirt and dust in a mine, as well as the appearance of gases (for example, in an underground mine), may influence the suitability of a solution for a trolley system in a mine. For instance, complex geometries, complex mechanisms (like hinges, and the like), detailed designs, small-sized components, and the like may not work in an environment, where dust and dirt are spreading with every truck passing by. Embodiments described herein refer to a solution of the above described problems taking into account the circumstances of a mine with a flexible, modular, robust design combined with methods and processes of relocating and reusing the complete system. The solution according to some embodiments described herein typically consists of multiple design elements as part of the system design: a) Substation is designed as modular pre-installed substation which is easy to transport, install and relocate b) the OHL design is simplified by removing messenger wire c) OHL design is simplified by bringing the feeder wires closer to contact wire and d) Foundations are designed to be flexible with modular and reusable design.

With a system and method according to embodiments described herein, it is possible to reduce emissions by reusability and improve/reduce the carbon footprint of the mine. Embodiments described herein address the problem with methods, processes, and design of the trolley system of a mine suitable to be relocated and reused in a different location of a mine. Solutions described herein reduce the CAPEX cost of the new trolley system.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practicing the present disclosure, from a study of the drawings, the disclosure, and the appended claims. In the claims, the word “comprising” does not exclude other elements or activities, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

The disclosed systems and methods are not limited to the specific embodiments described herein. Rather, components of the systems or activities of the methods may be utilized independently and separately from other described components or activities.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method for relocating a modular trolley system for a mining truck in a mine,
wherein the modular trolley system comprises:
a rectifier substation comprising a rectifier transformer;
a wire-pole-assembly comprising:
a foundation;
a wire holding beam; and
a pole element mounted to the foundation and holding the wire holding beam; and
conductors comprising a contact wire and a feeder wire;
wherein at least the rectifier substation and the wire-pole-assembly, or the foundation, the wire holding beam, and the pole element, are transportable trolley system elements which comprise a respective transport coupling section configured to:
couple the transportable trolley system element to a transport coupling tool; and
transport the transportable trolley system element;
the method comprising:
disconnecting at least some of the transportable trolley system elements of the modular trolley system at a first location of the mine, and coupling the respective at least some of the transportable trolley system elements to the transport coupling tool via the transport coupling section;
transporting the at least some of the transportable trolley system elements of the modular trolley system to a second location different from the first location; and
re-connecting the transported trolley system elements of the modular trolley system at the second location of the mine.

2. The method according to claim 1, wherein transporting and re-connecting the trolley system elements of the modular trolley system comprises transporting and re-connecting at least one of the rectifier substation, the foundation, the wire holding beam, and the pole element.

3. The method according to claim 1, wherein the modular trolley system further comprises a tension system configured to tension a plurality of wires, and
wherein disconnecting the at least some of the trolley system elements of the modular trolley system further comprises releasing the tension in the plurality of wires via the tension system.

4. The method according to claim 1, wherein disconnecting the at least some of the transportable trolley system elements of the modular trolley system further comprises at least one of:
removing the conductors, and rolling the conductors on a drum for transportation to the second location;
removing the conductors and dragging the contact wire on the ground; or
removing the contact wire during disconnection of the modular trolley system at the first location and replacing the contact wire during re-connection of the modular trolley system at the second location.

5. The method according to claim 1, wherein the foundation is partitioned into single foundation elements,
wherein disconnecting the at least some of the trolley system elements of the modular trolley system comprises disconnecting the foundation into the single foundation elements, and
wherein transporting the at least some of the trolley system elements of the modular trolley system comprises transporting the foundation as the single foundation elements.

6. The method according to claim 1, wherein the foundation is partitioned into single foundation elements, and
wherein re-connecting the at least some of the trolley system elements of the modular trolley system at the second location of the mine comprises re-connecting the single foundation elements of the foundation to form the foundation, and
wherein the method further comprises using additional elements with the single foundation elements of the foundation to increase stability of the foundation at the second location.

7. The method according to claim 1, wherein transporting the at least some of trolley system elements of the modular trolley system comprises mounting non-permanent tracks between the first location and the second location and transporting the at least some trolley system elements of the modular trolley system over the non-permanent tracks.

8. A relocatable modular trolley system configured to relocate a modular trolley system, the relocatable modular trolley system comprising:
a rectifier substation comprising a rectifier transformer;
a wire-pole-assembly comprising:
a foundation;
a wire holding beam; and
a pole element mounted to the foundation and holding the wire holding beam;
conductors comprising a contact wire and a feeder wire; and
a suspension system configured to hold the conductors placed on the wire holding beam;
wherein at least the rectifier substation and the wire-pole-assembly (623), or the foundation, the wire holding beam, and the pole element, are transportable trolley system elements which comprise a respective transport coupling section configured to:
couple the respective trolley system element to a transport coupling tool; and
transport the respective trolley system element, and
wherein the relocatable modular trolley system is configured to:
disconnect at least some of the transportable trolley system elements of the modular trolley system at a first location of the mine, and couple the respective at least some of the transportable trolley system elements to the transport coupling tool via the transport coupling section;
transport the at least some of the transportable trolley system elements of the modular trolley system to a second location different from the first location; and
re-connect the transported trolley system elements of the modular trolley system at the second location of the mine.

9. The relocatable modular trolley system according to claim 8, wherein:
the transport coupling tool grips the transportable trolley system element, the transportable trolley system element having the respective transport coupling section, to couple to the trolley system element, and to transport the trolley system element,
the transport coupling tool comprises a counterpart to the transport coupling section of the transportable trolley system element, and
the counterpart and the transport coupling section provide a connection to each other that allows transport of the trolley system element from the first location of the mine to the second location of the mine.

10. The relocatable modular trolley system according to claim 8, wherein the transport coupling section comprises at least one of a hook, a groove, a cavity, a belt, a wheel, a track wheel, a magnetic section, a rail or track counterpart, and a reinforced section; and
wherein the pole element and/or the foundation comprise hooks installed to lift and subsequently transport of the pole element and/or the foundation to the second location of the mine.

11. The relocatable modular trolley system according to claim 8, wherein at least two of the foundation, the wire holding beam, and the pole element have the transport coupling section configured to couple the respective trolley system element to the transport coupling tool and configured to transport the respective trolley system element.

12. The relocatable modular trolley system according to claim 8, wherein the transport coupling section of the substation and the transport coupling section of the wire-pole-assembly have substantially the same shape in order to couple to a same kind of transport coupling tool.

13. The relocatable modular trolley system according to claim 8, wherein the conductors comprise the contact wire and the feeder wire.

14. The relocatable modular trolley system according to claim 8, further comprising tracks configured to guide the at least some of the trolley system elements from the first location of the mine to the second location of the mine.

15. (canceled)

16. The relocatable modular trolley system according to claim 8, wherein in the transport and re-connect the trolley system elements, the relocatable modular trolley system is further configured to transport and re-connect at least one of the rectifier substation, the foundation, the wire holding beam, and the pole element.

17. The relocatable modular trolley system according to claim 8, further comprising a tension system configured to tension a plurality of wires, and
wherein in the disconnect the at least some of the trolley system elements, the relocatable modular trolley system is further configured to release the tension in the plurality of wires via the tension system.

18. The relocatable modular trolley system according to claim 8, wherein in the disconnect the at least some of the transportable trolley system elements, the relocatable modular trolley system is further configured to perform at least one of:
removing the conductors, and roll the conductors on a drum for transportation to the second location;
removing the conductors, and drag the contact wire on the ground; or
removing the contact wire during disconnection of the modular trolley system at the first location and replace the contact wire during re-connection of the modular trolley system at the second location.

19. The relocatable modular trolley system according to claim 8, wherein the foundation is partitioned into single foundation elements, and
wherein in the disconnect the at least some of the trolley system elements, the relocatable modular trolley system is further configured to disconnect the foundation into the single foundation elements, and
wherein in the transport the at least some of the trolley system elements, the relocatable modular trolley system is further configured to transport the foundation as the single foundation elements.

20. The relocatable modular trolley system according to claim 8, wherein the foundation is partitioned into single foundation elements, and
wherein in the re-connect the at least some of the trolley system elements, the relocatable modular trolley system is further configured to re-connect the single foundation elements of the foundation to form the foundation, and
wherein the relocatable modular trolley system is further configured to use additional elements with the single foundation elements of the foundation to increase stability of the foundation at the second location.

21. The method according to claim 1, wherein:
the transport coupling tool grips the transportable trolley system element, the transportable trolley system element having the respective transport coupling section, to couple to the trolley system element, and to transport the trolley system element,
the transport coupling tool comprises a counterpart to the transport coupling section of the transportable trolley system element, and
the counterpart and the transport coupling section provide a connection to each other that allows transport of the trolley system element from the first location of the mine to the second location of the mine.
